(19) United States
(12) Patent Application Publication
(10) Pub. No.: US 2024/0147160 A1
(43) Pub. Date: May 2, 2024

(54) HIGH-FREQUENCY SOUND-EMITTING DEVICE

(71) Applicant: FLATVOX FZC LLC, Ajman (AE)

(72) Inventors: Dmitry Vladimirovich PETRENKO, Afipsky (RU); Mikhail GORDEN, Dubai (AE)

(21) Appl. No.: 17/975,723

(22) Filed: Oct. 28, 2022

(51) Int. Cl. H04R 7/10; H04R 1/02; H04R 1/28; H04R 3/00

(52) U.S. Cl. CPC H04R 7/10; H04R 1/023; H04R 1/025; H04R 1/288; H04R 3/00; H04R 2307/021; H04R 2307/027

(57) ABSTRACT

A high-frequency (HF) sound-emitting device is provided, which comprises an open-ended hollow housing, an acoustic oscillator arranged inside the hollow housing and configured to generate HF sound oscillations, and a sound-emitting membrane attached to the acoustic oscillator. The sound-emitting membrane comprises a paper-based composite material layer, a metal layer, and a coating layer. The paper-based composite material layer has a top surface facing the open end of the hollow housing. The metal layer is provided on the top surface of the paper-based composite material layer and configured to reproduce the HF sound oscillations. The coating layer is provided on the metal layer and has one or more slots through which the metal layer is visible. The coating layer is made of a material incapable of reproducing the HF sound oscillations. With this configuration, the sound-emitting device may emit a fractal-polarized sound field.

### TECHNICAL FIELD

The present disclosure relates generally to the field of acoustic engineering. In particular, the present disclosure relates to a high-frequency (HF) sound-emitting device that is configured to emit a fractal-polarized sound field.

### BACKGROUND

There are many HF loudspeakers or, in other words, tweeters of various types, including domical, conical and plate sound emitters characterized by a different acoustic design, such as a horn design. The known disadvantages of the conventional HF loudspeakers are as follows: a high level of non-linear harmonic distortion, a high degree of unevenness of a sound beam, a drop in acoustic pressure proportional to a squared distance, an uneven amplitude-frequency response. The thing is that the design of the conventional HF loudspeakers does not provide for their operation as emitters of a fractal-polarized sound field.

The fractal-polarized sound field was discovered by the present authors when studying the features of sound production by flat surfaces and membranes. More specifically, the fractal-polarized sound field occurs when a flat membrane is bent under the influence of an applied acoustic vibration, thereby providing a pair of incoherent sources of standing waves which generate antiphase acoustic vibrations of one frequency or another into a surrounding space. Since these sources are spaced from each other over the membrane area, this results in forming zones of transverse polarization of sound, as well as zones of intermediate polarization of sound in the surrounding (air or gas) space. Thus, a spatial sound pattern consisting of the zones of different polarizations of sound is formed. This pattern is formed according to the following equation of fractal regularities (also referred to as the logistic difference equation): xn₊₁=rxₙ(1-xₙ), where r is the so-called driving parameter. The resulting fractal sound pattern is unique for each of the generated frequencies, both in terms of the size of the polarization zones and their geometry. In case of a broadband acoustic signal, this gives a huge variety of spatial fractal-polarized sound patterns, which allows providing a high degree of filling of the surrounding space with acoustic energy.

Without knowledge of the principle of formation of the fractal-polarized sound field, the conventional HF loudspeakers are designed to be mostly symmetrical, and their sound-emitting surfaces are not flat. Thus, at a certain frequency, conditions may be created for the occurrence of zones of opposing sound excitations in the form of the so-called “Chladni” figures on the curved sound-emitting surfaces, thereby causing an inevitable increase in the total area of the radiation zone at this frequency. As a result, there is an energy surge of acoustic energy at this frequency. Under such conditions, it is extremely difficult to keep an amplitude-frequency response curve flat over the entire operating frequency range.

### SUMMARY

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide a HF sound-emitting device that is configured to emit a fractal-polarized sound field.

The objective above is achieved by the features of the independent claim in the appended claims. Further embodiments and examples are apparent from the dependent claims, the detailed description, and the accompanying drawings.

According to an aspect, a sound-emitting device is provided. The device comprises a hollow housing having an open end and an acoustic oscillator arranged inside the hollow housing. The acoustic oscillator is configured to generate HF sound oscillations. The device further comprises a sound-emitting membrane attached to the acoustic oscillator. The sound-emitting membrane comprises a paper-based composite material layer, a metal layer, and a first coating layer. The paper-based composite material layer has a top surface and a bottom surface. The top surface faces the open end of the hollow housing. The metal layer is provided on the top surface of the paper-based composite material layer and configured to reproduce the HF sound oscillations. The first coating layer is provided on the metal layer and has at least one slot through which the metal layer is visible. The first coating layer is made of a material incapable of reproducing the HF sound oscillations. In the sound-emitting device thus configured, suitable conditions may be created for the formation of acoustic radiation in the form of the fractal-polarized sound field. Furthermore, the sound-emitting device thus configured may create a circular sound pattern, have a wide operating frequency range, have an extremely even amplitude-frequency response curve over the entire operating frequency range, radically reduce a level of non-linear harmonic distortion, and have a linear acoustic pressure drop characteristic that is directly proportional to increasing distance from the sound-emitting device. On top of that, the sound-emitting device thus configured may be simple to manufacture, efficient in terms of electroacoustic conversion and “natural sound” achievement, and less expensive (compared to the conventional HF loudspeakers).

In one exemplary embodiment, the sound-emitting device further comprises a second coating layer provided on the bottom surface of the paper-based composite material layer. The second coating layer is made of the same material as the first coating layer. By using the second coating, it is possible to improve the acoustic performance of the sound-emitting device.

In one exemplary embodiment, the hollow housing is made of one of a sound-absorbing material, a sound-scattering material, and a sound-transparent material. Each of these materials may be beneficial depending on particular applications of the sound-emitting device.

In one exemplary embodiment, the acoustic oscillator comprises one of an electrodynamic oscillator, a piezoelectric oscillator, and a hydraulic oscillator. By using any of these types of acoustic oscillators, it is possible to generate the HF sound oscillations more efficiently.

In one exemplary embodiment, the acoustic oscillator further comprises an antivibration spacer. In this embodiment, the acoustic oscillator is attached to the housing through the antivibration spacer. By so doing, it is possible to improve the vibration insulation of the sound-emitting device.

In one exemplary embodiment, the paper-based composite material layer is impregnated with a stabilizing composition based on one of varnish, polyurethane resin, polyester resin, and epoxy resin. By using the stabilizing composition, it is possible to give necessary physical and mechanical properties to the paper-based composite material layer (and, consequently, to the whole membrane structure). For example, such impregnation with the stabilizing composition may provide the desired elasticity modulus and elasticity-to-viscosity ratio of the paper-based composite material layer (e.g., an increase in its viscosity leads to a decrease in the speed of propagation of bending waves over the membrane surface and a change in tonal balance towards a decrease in a lower cutoff frequency), as well as lead to leveling the membrane surface (in order to reduce the level of harmonic distortion) and protect the membrane from moisture changes.

In one exemplary embodiment, the first coating layer is made of one of fleece, fabric, leather, and paper. The coating layer made of any of these materials may have a limited ability to radiate frequencies above 8 kHz by its surface, thereby improving the acoustic performance of the sound-emitting device.

In one exemplary embodiment, the sound-emitting device further comprises an acoustic amplifier coupled to the acoustic oscillator. By using the acoustic amplifier, it is possible to obtain the desired amplitude of the HF sound oscillations.

In one exemplary embodiment, the membrane has a geometrical shape calculated based on the elastic modulus of a paper-based composite material of the paper-based composite material layer. By using the membrane shape thus calculated, it is possible to improve the acoustic performance of the sound-emitting device.

In one exemplary embodiment, the elastic modulus of the paper-based composite material differs in longitudinal and transverse directions of the sound-emitting membrane by 2 times. The membrane in which the elastic modulus of the paper-based composite material changes in this way may improve the acoustic performance of the sound-emitting device even more.

In one exemplary embodiment, the sound-emitting membrane is shaped as an octagon. The octagonal membrane may provide the best acoustic performance of the sound-emitting device.

In one exemplary embodiment, the octagonal membrane has rounded corners. The rounded corners of the membrane may additionally improve the acoustic performance of the membrane.

In one exemplary embodiment, the sound-emitting membrane has a length-to-width ratio from 1 to 1.5 (preferably, 1.135). Such sizes of the membrane may improve acoustic performance of the sound-emitting device even more (especially when the membrane also has an octagonal shape).

In one exemplary embodiment, the paper-based composite material is configured as a three-layered structure comprising two flat paper layers and a layer of corrugated, foam or honeycomb material sandwiched between the two flat paper layers. Such a paper-based composite material layer may additionally improve the acoustic performance of the sound-emitting device.

In one exemplary embodiment, the sound-emitting device further comprises a sound-transparent mesh covering the open end of the hollow housing. This mesh may be used for protection of the membrane from damage.

Other features and advantages of the present disclosure will be apparent upon reading the following detailed description and reviewing the accompanying drawings.

### BRIEF DESCRIPTION OF THE DRAWINGS

The present disclosure is explained below with reference to the accompanying drawings in which:

FIG. 1 shows a schematic exploded view of a high-frequency (HF) sound-emitting device in accordance with one exemplary embodiment;

FIG. 2 shows a schematic exploded view of a sound-emitting membrane included in the device of FIG. 1;

FIG. 3 explains how to calculate the geometry of the membrane of FIG. 2;

FIG. 4 shows a possible zone of attachment of an acoustic oscillator included in the device of FIG. 1 to the membrane of FIG. 2; and

FIGS. 5A and 5B show amplitude-frequency response curves obtained for conventional HF loudspeaker Dragster DTH 125 (see FIG. 5A) and the device of FIG. 1 (see FIG. 5B).

### DETAILED DESCRIPTION

Various embodiments of the present disclosure are further described in more detail with reference to the accompanying drawings. However, the present disclosure may be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the apparatus disclosed herein may be implemented in practice by using any numbers of the embodiments provided herein. Furthermore, it should be understood that any embodiment of the present disclosure may be implemented using one or more of the features presented in the appended claims.

The word “exemplary” is used herein in the meaning of “used as an illustration”. Unless otherwise stated, any embodiment described herein as “exemplary” should not be construed as preferable or having an advantage over other embodiments.

Any positioning terminology, such as “left”, “right”, “top”, “bottom”, “above” “below”, “upper”, “lower”, “horizontal”, “vertical”, etc., may be used herein for convenience to describe one element's or feature's relationship to one or more other elements or features in accordance with the figures. It should be apparent that the positioning terminology is intended to encompass different orientations of the apparatus disclosed herein, in addition to the orientation(s) depicted in the figures. As an example, if one imaginatively rotates the apparatus in the FIGS. 90 degrees clockwise, elements or features described as “left” and “right” relative to other elements or features would then be oriented, respectively, “above” and “below” the other elements or features. Therefore, the positioning terminology used herein should not be construed as any limitation of the invention.

Although the numerative terminology, such as “first”, “second”, etc., may be used herein to describe various embodiments, elements or features, these embodiments, elements or features should not be limited by this numerative terminology. This numerative terminology is used herein only to distinguish one embodiment, element or feature from another embodiment, element or feature. For example, a first coating layer discussed below could be called a second coating layer, and vice versa, without departing from the teachings of the present disclosure.

The exemplary embodiments disclosed herein relate to a high-frequency (HF) sound-emitting device that comprises an open-ended hollow housing, an acoustic oscillator arranged inside the hollow housing and configured to generate HF sound oscillations, and a sound-emitting membrane attached to the acoustic oscillator. The sound-emitting membrane comprises a paper-based composite material layer, a metal layer, and a coating layer. The paper-based composite material layer has a top surface facing the open end of the hollow housing. The metal layer is provided on the top surface of the paper-based composite material layer and configured to reproduce the HF sound oscillations. The coating layer is provided on the metal layer and has one or more slots through which the metal layer is visible. The coating layer is made of a material incapable of reproducing the HF sound oscillations. With this configuration, the sound-emitting device may emit a fractal-polarized sound field.

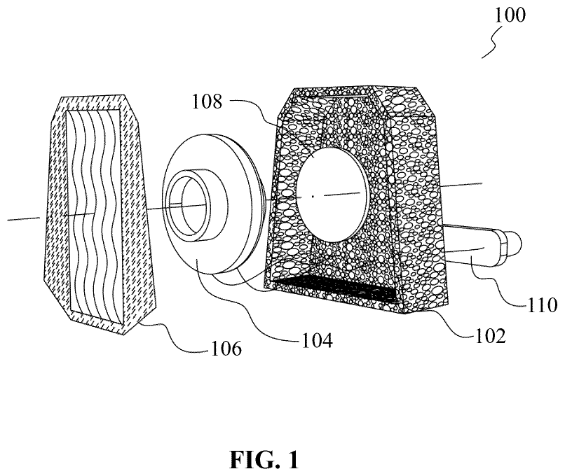

FIG. 1 shows a schematic exploded view of a HF sound-emitting device 100 in accordance with one exemplary embodiment. The device 100 comprises a hollow housing 102 having an open (front) end, an acoustic oscillator 104, and a sound-emitting membrane 106 (only its top surface is shown in FIG. 1). The hollow housing 102 may be made of a sound-absorbing material, a sound-scattering material, or a sound-transparent material. The acoustic oscillator 104 is arranged inside the hollow housing 102 and configured to generate HF sound oscillations. Those skilled in the art would recognize that HF sound is sound of which the frequency lies between 8 and 20 kHz. The acoustic oscillator 104 may of any type, such as electrodynamic, piezoelectric, hydraulic, and is attached (e.g., glued, adhered, or screwed) directly to the inner surface of the hollow housing 102. It should be noted that the membrane 106 does not have attachment points to the hollow housing 102 along its perimeter but is attached exclusively to the acoustic oscillator 104. As also shown in FIG. 1, the device 100 comprises an optional antivibration spacer 108 through which the acoustic oscillator 104 is attached to the inner surface of the hollow housing 102. The device 100 may optionally comprise an acoustic amplifier (not shown) coupled to the acoustic oscillator 104 via terminals 110, as well as an acoustically transparent mesh (not shown) covering the open end of the hollow housing 102 for the purpose of protecting the membrane 106 from mechanical damage.

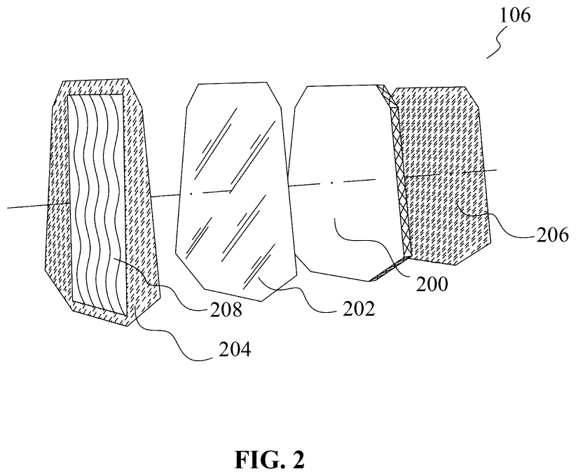

FIG. 2 shows a schematic exploded view of the membrane 106 included in the device 100. As shown in FIG. 2, the membrane 106 is implemented as a multi-layered structure that comprises a paper-based composite material layer 200, a metal layer 202, a first coating layer 204, and a second coating layer 206. The paper-based composite material layer 200 is intended to be arranged such that its top surface faces the open end of the hollow housing 102. The paper-based composite material layer 200 itself may be configured as a multi-layered structure, such as two flat paper layers with a layer of corrugated, foam or honeycomb material sandwiched therebetween. The metal layer 202 is provided on the top surface of the paper-based composite material layer 200. The metal layer 202 may be made of any metal configured to reproduce the HF sound oscillations generated by the acoustic oscillator 104. The first coating layer 204 is provided on (e.g., glued to) the metal layer 202 and has multiple slots 208 through which the metal layer 202 is visible (i.e., the slots 208 are through). The second coating layer 206 is provided on (e.g., glued to) the bottom surface of the paper-based composite material layer 200 and is an optional constructive element of the membrane 106. Each of the first and the second coating layers 204, 206 may be made of the same material, and the condition for choosing this material is its inability to effectively reproduce the HF sound oscillations with frequencies above 8 kHz. Some examples of the material for each of the first and second coating layers 204, 206 may include, but not limited to, fleece, fabric, leather, and paper.

It should be noted that the number, arrangement, and shape of the slots 208, which are shown in FIG. 2, are not intended to be any limitation of the present disclosure, but merely used to provide a general idea of how the slots 208 may be made in the membrane 106. For example, the slots 208 may have any straight, angled or curved (e.g., annular, zigzag, polygonal, etc.) shape. In some embodiments, the slots 208 may be similarly or differently shaped (e.g., one part of the slots 208 may have an annular shape, while another part of the slots 208 may be in the form of zigzag). One other embodiment is possible, in which the coating layer 204 has only one slot 208. In general, the shape, size, and number of the slots 208 may be any, depending on a specific technical problem aimed at achieving a desired balance in the emission of different frequencies by the surface of the membrane 106. In other words, by changing the shape, size, and number of the slots 208, it is possible to control the return of sound energy by the membrane 106 in a particular frequency range.

Further, the number and shape of the slots 208 influence a sound pattern formed on the surface of the membrane 106. Since the metal layer 202 may radiate higher frequencies more energetically, and the coating layer 204 may radiate lower frequencies only, then the shape and size of such a sound pattern may control the balance of the energy of the return of sound waves by the membrane 106 in the entire frequency range of the membrane 106.

In one embodiment, the paper-based composite material layer 200 may be impregnated with a stabilizing composition based on one of varnish, polyurethane resin, polyester resin, and epoxy resin. By so doing, it is possible to provide desired physical and mechanical properties of the paper-based composite material layer 200 and the membrane 106 in general.

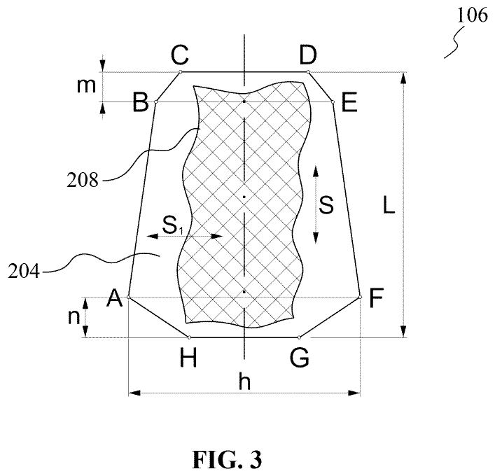

FIG. 3 explains how to calculate the geometry of the membrane 106. The shape and dimensions of the membrane 106 are critical to provide good acoustic performance of the device 100. When viewed from the front, the membrane 106 is an octagon having vertices A, B, C, D, E, F, G, and H. The basis for calculating the geometry of the membrane 106 is an elastic modulus of the material selected for the paper-based composite material layer 200. As noted above, this material may be made in the form of a three-layer structure having a three-dimensional base (corrugated, honeycomb, foam, or other similar material) and flat paper layers glued to the three-dimensional base on both sides. The geometry of the paper-based composite material layer 200 may be calculated based on the difference in the elasticity modulus in longitudinal and transverse directions according to the following formula: S/S1=1/2, where S is the elasticity modulus in the longitudinal direction, 51 is the elasticity modulus in the transverse direction. For calculations, the elasticity modulus of a suitable material is calculated in millinewton/meter (mN/m). The elasticity modulus S is the basis for determining the absolute length L of the membrane 106 according to the following formula: L=28*S (mN/m). The absolute width h of the membrane 106 is determined by the following ratio: L/h=1.135 (this ratio may vary from 1 to 1.5 in different embodiments, but the ratio value of 1.135 is preferable, e.g., for the octagonal membrane 106). The remaining proportions of the membrane 106 are determined according to the following list of ratios: AF/HG=1.9; HG=CD; L/n=6; n/m=1.35; AF/BE=1.35. The fact that the membrane 106 is made symmetrical about is vertical axis is also taken into account.

It should be apparent to those skilled in the art that the present disclosure is not limited to the octagonal shape of the membrane 106. The octagonal membrane 106 is preferable, but any other membrane shape (e.g., other polygonal shapes, such as square, triangular, rectangular, etc.) is also possible (for such other membrane shapes, one may use similar calculations as those given above with reference to FIG. 3).

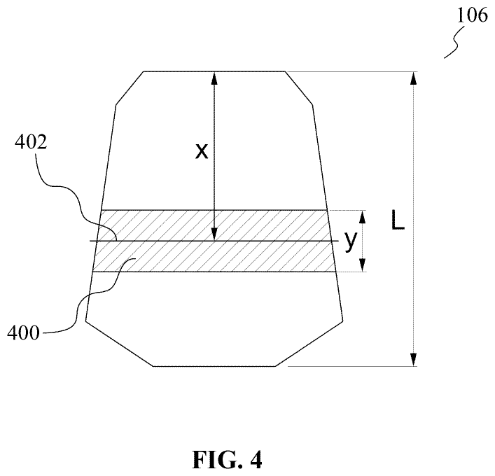

FIG. 4 shows a zone 400 of possible attachment of the acoustic oscillator 104 included in the device 100 to the membrane 106. In FIG. 4, a line 402 corresponds to a fastening line of the center of the acoustic oscillator 104, and its position may vary within the zone 400. The zone 400 has a width y, and the line 402 is positioned at a distance x from the top end of the membrane 106. To calculate y and x, one may use the following ratios: L/y=4, and L/x=1.8.

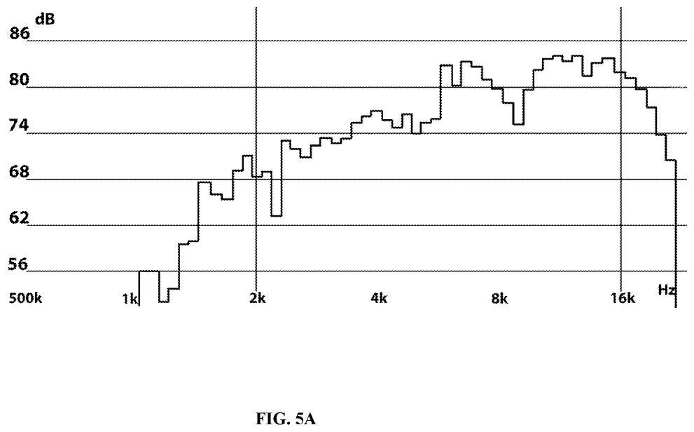

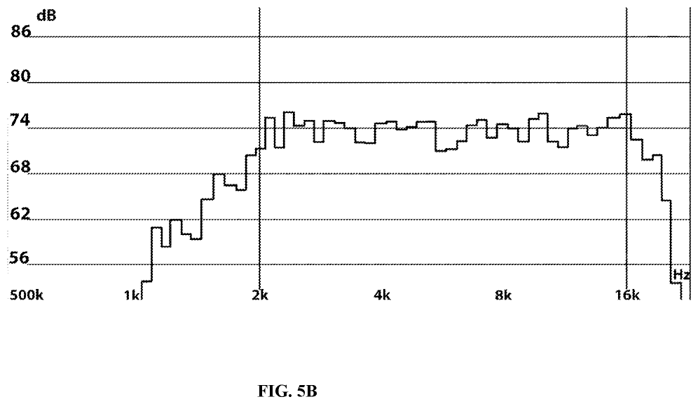

FIGS. 5A and 5B show amplitude-frequency response curves obtained for conventional HF loudspeaker Dragster DTH 125 (see FIG. 5A) and the device 100 (see FIG. 5B). As can be seen, unlike HF loudspeaker Dragster DTH 125, the amplitude-frequency response curve of the device 100 is kept relatively flat over the entire operating frequency range. Thus, the amplitude-frequency response curve of the device 100 may be leveled without having to use special electronic correction means.

Although the exemplary embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. A sound-emitting device comprising:
a hollow housing having an open end;
an acoustic oscillator arranged inside the hollow housing and configured to generate high-frequency (HF) sound oscillations; and
a sound-emitting membrane attached to the acoustic oscillator and comprising:
a paper-based composite material layer having a top surface and a bottom surface, the top surface facing the open end of the hollow housing;
a metal layer provided on the top surface of the paper-based composite material layer and configured to reproduce the HF sound oscillations; and
a first coating layer provided on the metal layer and having at least one slot through which the metal layer is visible, the first coating layer being made of a material incapable of reproducing the HF sound oscillations.

2. The device of claim 1, further comprising a second coating layer provided on the bottom surface of the paper-based composite material layer, the second coating layer being made of the same material as the first coating layer.

3. The device of claim 1, wherein the hollow housing is made of one of a sound-absorbing material, a sound-scattering material, and a sound-transparent material.

4. The device of claim 1, wherein the acoustic oscillator comprises one of an electrodynamic oscillator, a piezoelectric oscillator, and a hydraulic oscillator.

5. The device of claim 1, further comprising an antivibration spacer, and wherein the acoustic oscillator is attached to the housing through the antivibration spacer.

6. The device of claim 1, wherein the paper-based composite material layer is impregnated with a stabilizing composition based on one of varnish, polyurethane resin, polyester resin, and epoxy resin.

7. The device of claim 1, wherein the first coating layer is made of one of fleece, fabric, leather, and paper.

8. The device of claim 1, further comprising an acoustic amplifier coupled to the acoustic oscillator.

9. The device of claim 1, wherein the sound-emitting membrane has a geometrical shape calculated based on an elastic modulus of a paper-based composite material of the paper-based composite material layer.

10. The device of claim 9, wherein the elastic modulus of the paper-based composite material differs in longitudinal and transverse directions of the sound-emitting membrane by 2 times.

11. The device of claim 9, wherein the sound-emitting membrane is shaped as an octagon.

12. The device of claim 11, wherein the octagon has rounded corners.

13. The device of claim 1, wherein the sound-emitting membrane has a length-to-width ratio from 1 to 1.5.

14. The device of claim 1, wherein the paper-based composite material layer is configured as a three-layered structure comprising:
two flat paper layers; and
a layer of corrugated, foam or honeycomb material sandwiched between the two flat paper layers.

15. The device of claim 1, further comprising a sound-transparent mesh covering the open end of the hollow housing.
